(19) United States
(12) Patent Application Publication
(10) Pub. No.: US 2004/0126503 A1
(43) Pub. Date: Jul. 1, 2004

(54) Process for laser marking of a liquid crystal film

(76) Inventors: Matthias Kuntz, Seeheim-Jugenheim (DE); Reiner Delp, Darmstadt (DE); John Patrick, Dorset (GB); Rodney Riddle, Dorset (GB); Robert Hammond-Smith, Hampshire (GB)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/737,792

(22) Filed: Dec. 18, 2003

(30) Foreign Application Priority Data
Dec. 19, 2002 (EP) 02028174.7

(51) Int. Cl. C08J 7/18

(52) U.S. Cl. 427/555

(57) ABSTRACT

The invention relates to process for laser marking of a liquid crystal film. The invention further relates to a liquid crystal film obtained by this method and to its use in optical, decorative or security applications, for optical information storage or the preparation of liquid crystal pigments.

### FIELD OF THE INVENTION

The invention relates to a process for laser marking of a liquid crystal film. The invention further relates to a liquid crystal film obtained by this method and to its use in optical, decorative or security applications, for optical information storage or the preparation of liquid crystal pigments.

### BACKGROUND OF THE INVENTION

Liquid crystal polymer (LCP) films comprising polymerized liquid crystal material can be produced with various properties which are especially suitable for optical, decorative or security applications and for optical information storage.

Thus, reflective LCP films with an angular dependant reflection color can be generated from cholesteric liquid crystal mixtures, or nematic LCP films can be used in applications such as hot stamping foils. These films are usually prepared by coating a thin layer of a polymerizable LC mixture onto a substrate, aligning the mixture into uniform orientation and polymerizing the mixture to fix the structure.

For several applications it is desired to add further patterns or images to the LCP film. This is usually achieved by the use of two or more steps of photopolymerization, e.g. by polymerization under different conditions and/or using photoisomerizable, photoorienting or thermochromic materials that change their properties between the different curing steps, in combination with photomasking techniques and/or photopolymerization with linear polarized light.

Another method to provide a visible marking in an LCP film is reported in U.S. Pat. No. 6,207,240. This reference describes an effect coating of a cholesteric liquid crystal polymer (CLCP) with viewing angle dependent reflection color which further comprises absorption type pigments exhibiting a specific absorption color. A marking, such as a symbol or text, is generated in the CLCP coating by laser irradiation. The laser radiation carbonizes the CLCP material in the irradiated area. As a result, the color of the substrate on which the CLCP is coated, or the color of absorption pigments incorporated into the CLCP, become visible in the irradiated area. However, the method as described for example in U.S. Pat. No. 6,207,240 is limited to cholesteric LC materials and requires high powered lasers to carbonize the material such that the markings are visible.

### SUMMARY OF THE INVENTION

It is an aim of the present invention to provide a process for marking a liquid crystal film that does not have the drawbacks of the prior art, yields markings with good visibility, is time and cost-effective, does not have the limitations of the prior art materials, can be applied to a broad variety of substrates, surfaces and objects, and allows a fast, reliable and economic fabrication even at large scales.

A further aim of this invention relates to a liquid crystal film comprising a marking obtained by the process according to this invention, which is particularly suitable for optical, decorative, security, authentification or identification applications.

A further aim of this invention is to provide an advantageous use of a marked liquid crystal film according to this invention.

Further aims of this invention relate to security, authentification or identification markings or devices and optical data storage devices, which are difficult to counterfeit.

Other aims of the present invention are immediately evident to the person skilled in the art from the following detailed description.

The inventors have found that these aims can be achieved by providing a process for laser marking of a liquid crystal film according to the present invention.

The invention relates to a process for generating a marking in a liquid crystal film by laser irradiation, wherein the liquid crystal film comprises a polymerized liquid crystal material and one or more interference pigments.

The invention further relates to a liquid crystal film with a laser marking obtained by the process as described above and below.

The invention further relates to the use of a liquid crystal film as described above and below in optical, decorative, security, authentification or identification applications, for optical information storage or for the preparation of liquid crystal pigments.

The invention further relates to a film, marking, thread, strip or device for optical, decorative, security, authentification or identification purposes, comprising a liquid crystal film as described above and below or comprising one or liquid crystal pigments prepared from such a film.

The invention further relates to documents of value, hot stamping foils, transfer foils, reflective foils and optical data storage devices, each comprising at least one film, marking, thread or device according to this invention.

Definition of Terms

The term ‘film’ as used in this application includes self-supporting, i.e. freestanding, films that show more or less pronounced mechanical stability and flexibility, as well as coatings or layers on a supporting substrate or between two substrates.

The term ‘liquid crystal or mesogenic material’ or ‘liquid crystal or mesogenic compound’ means materials or compounds comprising one or more rod-shaped, board-shaped or disk-shaped mesogenic groups, i.e. groups with the ability to induce liquid crystal phase behavior. Liquid crystal compounds with rod-shaped or board-shaped groups are also known in the art as ‘calamitic’ liquid crystals. Liquid crystal compounds with a disk-shaped group are also known in the art as ‘discotic’ liquid crystals. The compounds or materials comprising mesogenic groups do not necessarily have to exhibit a liquid crystal phase themselves. It is also possible that they show liquid crystal phase behavior only in mixtures with other compounds, or when the mesogenic compounds or materials, or the mixtures thereof, are polymerized.

For the sake of simplicity, the term ‘liquid crystal material’ is used hereinafter for both liquid crystal materials and mesogenic materials, and the term ‘mesogen’ is used for the mesogenic groups of the material.

The ‘director’ is the preferred orientation direction of the long molecular axes (in case of calamitic compounds) or short molecular axis (in case of discotic compounds) of the mesogens in a liquid crystal material.

The term ‘planar structure’ or ‘planar orientation’ refers to a layer or film of liquid crystal material wherein the director is substantially parallel to the plane of the film or layer.

The term ‘homeotropic structure’ or ‘homeotropic orientation’ refers to a layer or film of liquid crystal material wherein the director is substantially perpendicular to the film plane, i.e. substantially parallel to the film normal.

The term ‘tilted structure’ or ‘tilted orientation’ refers to a layer or film of liquid crystal material wherein the director is tilted at an angle of between 0 and 90 degrees relative to the film plane.

The term ‘splayed structure’ or ‘splayed orientation’ means a tilted orientation as defined above, wherein the tilt angle varies monotonously in the range from 0 to 90°, preferably from a minimum to a maximum value, in a direction perpendicular to the film plane.

For sake of simplicity, a film comprising liquid crystal material with a tilted, splayed, low tilted, planar and homeotropic orientation or structure is hereinafter also referred to as ‘tilted film’, ‘splayed film’, ‘low tilt film’, ‘planar film’ and ‘homeotropic film’, respectively.

### DETAILED DESCRIPTION OF THE INVENTION

The present invention relates to a way of laser marking a pattern or design into a liquid crystal polymer film that comprises interference pigments, which are selected to absorb, at least partially the laser energy, like for example the commercially available Iriodin® LS range of pigments (from Merck KGaA, Darmstadt, Germany).

The method according to the present invention has significant advantages over prior art technology. Thus, the use of expensive special materials, curing masks, at least two stages of photopolymerization and/or more than one coating process is avoided. Also, where the current invention implies the usual coating and curing stages for preparing the polymer film, the manufactured film can simply and quickly be marked by incorporating a laser stage after the curing stage and before the rewind. The speed of laser marking is thus not a limiting factor in the speed of film production.

To prepare a polymer film, the polymerizable liquid crystal material comprising the laser absorbing interference pigments is typically applied as a thin layer on a substrate, aligned into uniform orientation, polymerized or crosslinked to fix the orientation molecules, and optionally the substrate is removed from the polymerized film. A marking for example in the form of a pattern, design or text is then inscribed into the film by exposure to laser intensity light. The interference pigments incorporated into the liquid crystal material are activated by the laser to give rise to the additional markings. The absorption of energy by the pigment causes a localized heating of the surrounding liquid crystal material which in turns destroys the optical properties (e.g., reflection of polarized light, birefringence etc.) of the liquid crystal material. This in turn can be seen as a visible effect in the liquid crystal polymer layer, namely a loss of angular color dependence in the case of cholesteric liquid crystal polymers and a loss of birefringence in the case of nematic liquid crystal polymers. The effect in nematic materials will be particularly apparent when viewed through a linear polarizer.

Preferably the polymerizable liquid crystal material is a nematic, smectic, chiral nematic (cholesteric) or chiral smectic material.

Preferably, in case of nematic liquid crystal materials, the polymerized material exhibits planar orientation, although other orientations like for example tilted or splayed are also possible.

In a preferred embodiment the polymerizable liquid crystal material is a nematic liquid crystal material. A film prepared from such a material is transparent when viewed at normal conditions, but shows a pattern of interference colors when viewed through a linear polarizer against a reflective background or when viewed between two linear polarizers. The laser marking will thus appear in such a film as a black marking in the interference pattern of the nematic material when viewed through a polarizer or between two polarizers.

The above embodiment is particularly suitable for use as false-proof security markings or security threads on banknotes or documents of value, by which the document is easy to authenticate when viewed either directly in the case of cholesteric materials, or, in the case of nematic materials, when viewed through one polarizer against a reflective background or between two polarizers.

The pigments incorporated into the liquid crystal film are preferably selected from pearlescent or interference pigment flakes comprising a substrate of e.g. mica, SiO2, Al2O3, TiO2 or glass that is coated with one or more layers of e.g. titanium dioxide, iron oxide, titanium iron oxide or chrome oxide or combinations thereof, or flakes comprising combinations of metal and metal oxide. Further preferred are metal flakes of e.g. aluminum coated with layers of iron oxide layers and/or silicium dioxide. Particularly suitable pearlescent pigments are the commercially available Iriodin® pigments, such as Iriodin LS800, LS820 or LS825, Xirallic® or Colourstream® pigments (from Merck KGaA, Darmstadt, Germany), or Paliochrome® pigments (from BASF AG, Ludwigshafen, Germany).

The amount of the interference pigments in the liquid crystal material is preferably from 0.05 to 30%, in particular from 0.1 to 10%, very preferably from 0.5 to 5%, by weight.

Further additives, like for example absorptive pigments or dyes can also be incorporated into the films to provide additional effects.

The laser used for marking the film can be a commercially available laser. The wavelength of laser irradiation is typically in the range from 150 to 1100 nm. Suitable and preferred lasers are selected from the group comprising CO2 lasers, Nd:YAG lasers, frequency-tripled Nd:YAG lasers (355 nm), frequency-quadrupled Nd:YAG lasers (266 nm) or UV lasers. Preferred UV lasers are excimer lasers, such as F2 excimer lasers (157 nm), ArF excimer lasers (193 nm), KrCI excimer lasers (222 nm), KrF excimer lasers 248 nm), XeCI excimer lasers (308 nm) and XeF excimer lasers (351 nm).

The lasers have typically an energy density (power) of 0.3 mJ cm-1 to 50 J cm-1, preferably of 0.5 mJ cm-1 to 20 J cm-1 and particularly 1 mJ cm-1 to 10 J cm-1.

The pulse frequency is typically from 0.1 to 10000 Hz, preferably from 1.0 to 1000 Hz. The pulse length is typically from 0.1 to 1000 ns, preferably from 1.0 to 100 ns.

The above values should not be taken as exclusive for the inventive process. Other wavelengths, powers and pulse lengths and frequencies may also be used to produce the same effect. Operating conditions for different machines will be different from those stated above and the nature of conditions required will depend upon the size and definition of the required marking.

Preferred embodiments of the invention relate to a method wherein

the liquid crystal material is a nematic material,

the liquid crystal material is crosslinked,

the liquid crystal material shows birefringent patterns when viewed between linear polarizers,

the interference pigments are selected from the group consisting of coated mica, silica or alumina pigments

the interference pigments are selected from the group consisting of Iriodin® Pigments, in particular Iriodin® LS800 or LS825 (commercially available from Merck KgaA, Darmstadt, Germany),

the laser light has a wavelength of 800 to 1200 nm,

the laser light has a power of from 50 to 150 W,

the laser light has a pulse length from 1 to 100 nsec.

The above described technique can be applied to any LCP material.

The liquid crystal material can be applied onto a substrate by conventional coating techniques like spin-coating or blade coating. It can also be applied to the substrate by conventional printing techniques which are known to the expert, like for example screen printing, offset printing, reel-to-reel printing, letter press printing, gravure printing, rotogravure printing, flexographic printing, intaglio printing, pad printing, heat-seal printing, ink-jet printing or printing by means of a stamp or printing plate.

Suitable substrates include films, paper, board, leather, cellulose sheeting, textiles, plastics, glass, ceramics and metals. Suitable plastic substrates are for example films of polyester such as polyethyleneterephthalate (PET) or polyethylenenaphthalate (PEN), polyvinylalcohol (PVA), polycarbonate (PC) or triacetylcellulose (TAC), especially preferably PET or TAC films.

In a preferred embodiment the substrate is a metallic or metallized film of e.g. aluminum. Further preferred are substrates covered by one or more layers of pearlescent or interference pigments or liquid crystal pigments, or mixtures thereof, which are dispersed in a transparent binder.

The substrate or at least the surface of the substrate covered by the liquid crystal material is preferably flat, like e.g. a foil, film or sheet, and has preferably a thickness smaller than 200 μm, in particular smaller than 60 μm, most preferably smaller than 20 μm.

The substrate surface is preferably planar, but may also be structured, patterned and/or have a relief. The shape, structure, pattern and/or relief of the substrate is preferably adapted to the desired application of the liquid crystal film. Suitable structuring and patterning techniques are well known to the one skilled in the art, in particular in the fields of precision engineering and microtechnology, and include lithography, etching, cutting, stamping, punching, embossing, molding and electron discharge machining techniques.

It is also possible to use a reflective substrate comprising a hologram or kinegram, a holographic layer with an embossed, patterned or structured surface, or a layer of reflective holographic pigments. Light reflected by higher regions of the structured surface will interfere with light reflected by lower regions of the structured surface, thereby forming a holographic image.

The polymerizable liquid crystal material may be applied onto one side or on both sides of the substrate. It may for example be printed onto discrete regions of the substrate to form a pattern or image, or printed or coated onto the entire substrate to form a continuous layer or film.

Preferably the liquid crystal film is prepared by applying a mixture comprising the liquid crystal material and one or more interference pigments onto the substrate. The mixture can also be applied as solution, dispersion or emulsion of the liquid crystal material in a suitable solvent, and the solvent is then evaporated before or during polymerization. Preferably a solution is used. The solvent may evaporate with or without the use of external forces such as heat or reduced pressure.

The liquid crystal material may additionally comprise a polymeric binder or one or more monomers capable of forming a polymeric binder and/or one or more dispersion auxiliaries. Suitable binders and dispersion auxiliaries are disclosed for example in WO 96/02597. Especially preferred are liquid crystal materials not containing a binder or dispersion auxiliary.

The polymerizable liquid crystal material preferably comprises at least one polymerizable mesogenic compound having one polymerizable functional group (monoreactive compound) and at least one polymerizable mesogenic compound having two or more polymerizable functional groups (di- or multireactive compound).

If di- or multireactive compounds are present in the polymerizable material, a three-dimensional polymer network is formed and the planar orientation of the LCP material is permanently fixed. A polymer film made of such a network is self-supporting and shows a high mechanical and thermal stability and a low temperature dependence of its physical and optical properties.

By varying the concentration of the di- and multireactive compounds the crosslink density of the polymer film and thereby its physical and chemical properties such as the glass transition temperature, which is also important for the temperature dependence of the optical properties of the optical retardation film, the thermal and mechanical stability or the solvent resistance can be tuned easily.

A preferred polymerizable liquid crystal material comprises

3-60%, very preferably 5 to 35% of one or more direactive achiral mesogenic compounds,

20-90%, very preferably from 30 to 80% of one or more monoreactive achiral mesogenic compounds,

0.05 to 30%, in particular 0.1 to 10%, very preferably 0.5 to 5% of one or more interference pigments,

0 to 15%, preferably 0.5 to 10% of one or more photoinitiators.

The polymerizable mesogenic mono-, di- or multireactive compounds used for the present invention can be prepared by methods which are known per se and which are described, for example, in standard works of organic chemistry such as, for example, Houben-Weyl, Methoden der organischen Chemie, Thieme-Verlag, Stuttgart. Typical examples are described for example in WO 93/22397; EP 0 261 712; DE 19504224; DE 4408171 and DE 4405316. The compounds disclosed in these documents, however, are to be regarded merely as examples that do not limit the scope of this invention.

Examples representing especially useful monoreactive polymerizable mesogenic compounds are shown in the following list of compounds, which should, however, be taken only as illustrative and is in no way intended to restrict, but instead to explain the present invention:

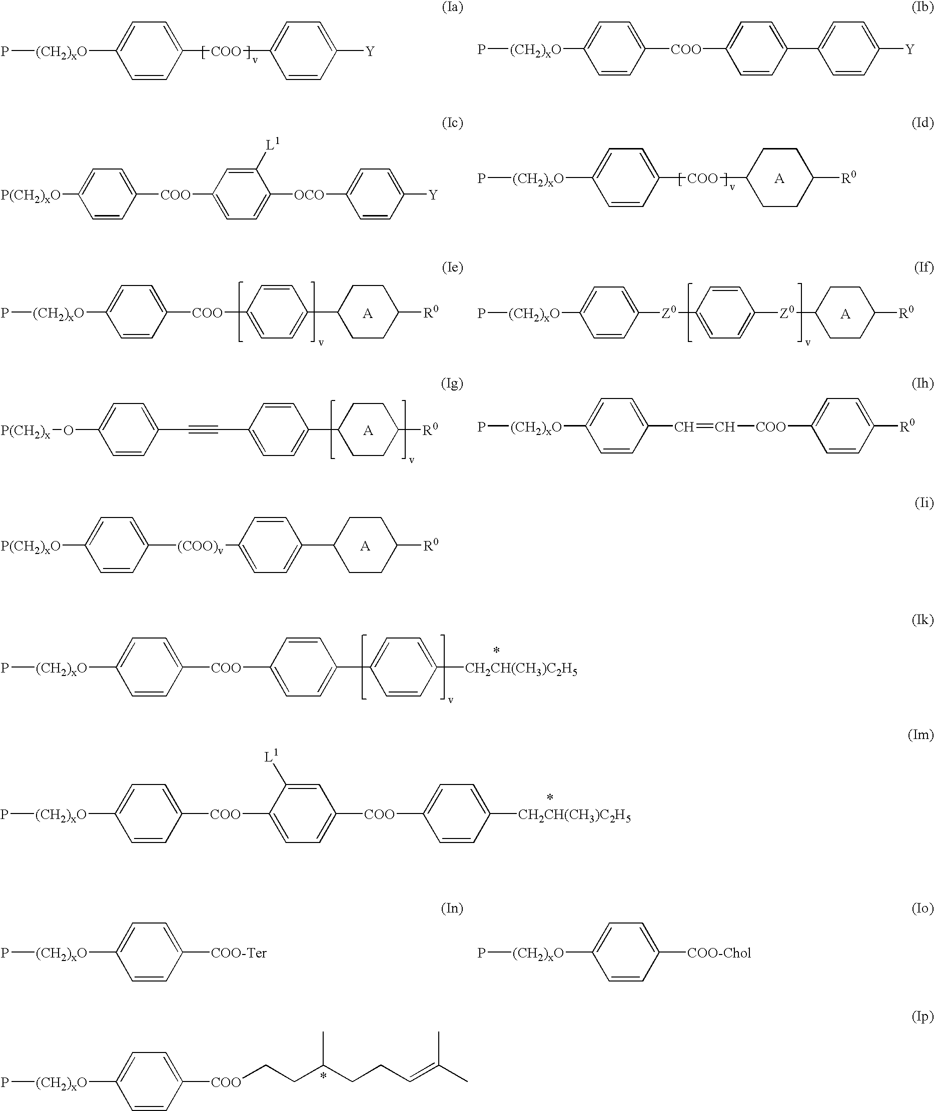

Examples of useful direactive polymerizable mesogenic compounds are shown in the following list of compounds, which should, however, be taken only as illustrative and is in no way intended to restrict, but instead to explain the present invention

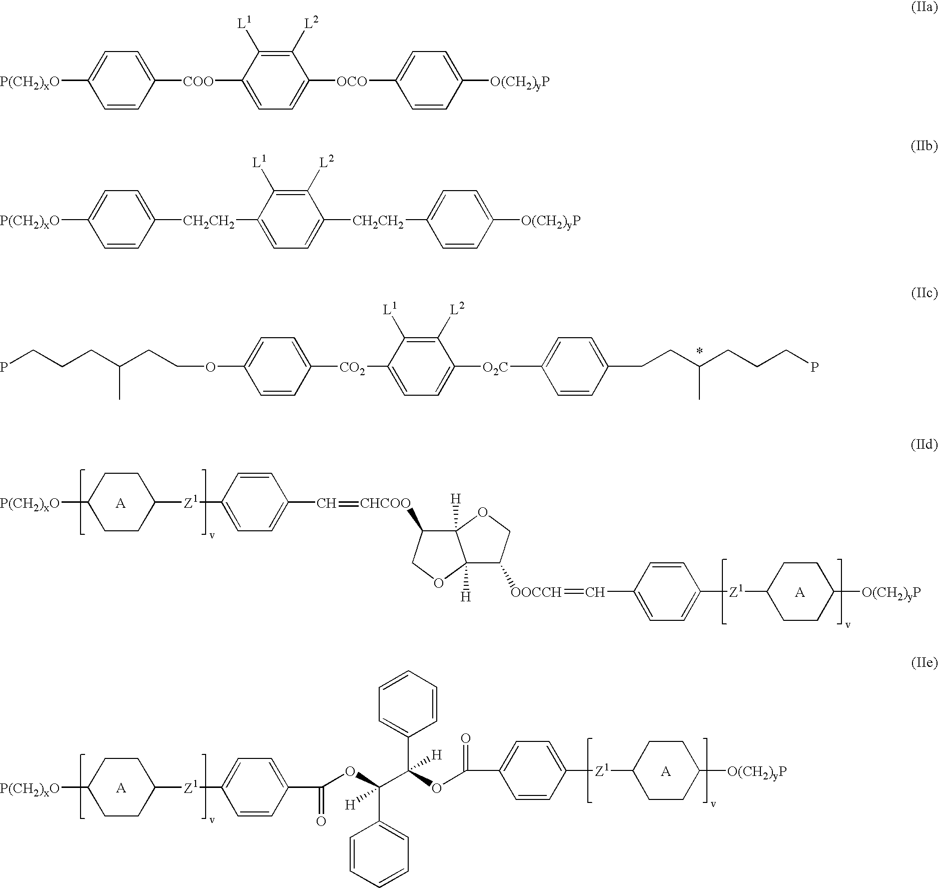

In the above formulae, P is a polymerizable group, preferably an acryl, methacryl, vinyl, vinyloxy, propenyl ether, epoxy or styryl group, x and y are each independently 1 to 12, A is 1,4-phenylene that is optionally mono-di or trisubstituted by L1 or 1,4-cyclohexylene, v is 0 or 1, Z0 is —COO—, —OCO—, —CH2CH2— or a single bond, Y is a polar group, Ter is a terpenoid radical like e.g. menthyl, Chol is a cholesteryl group, R0 is an unpolar alkyl or alkoxy group, and L1 and L2 are each independently H, F, Cl, CN or an optionally halogenated alkyl, alkoxy, alkylcarbonyl, alkoxycarbonyl or alkoxycarbonyloxy group with 1 to 7 C atoms.

The term ‘polar group’ means a group selected from F, Cl, CN, NO2, OH, OCH3, OCN, SCN, an optionally fluorinated carbonyl or carboxyl group with up to 4 C atoms or a mono-oligo- or polyfluorinated alkyl or alkoxy group with 1 to 4 C atoms. The term ‘unpolar group’ means an alkyl group with 1 or more, preferably 1 to 12 C atoms or an alkoxy group with 2 or more, preferably 2 to 12 C atoms.

In case CLC materials are used, these preferably comprise a nematic or smectic host material and one or more chiral dopants that induce a helical twist in the host material. The chiral dopants can be polymerizable or not. They can be mesogenic or liquid crystal compounds, but do not necessarily have to be liquid crystalline.

Suitable polymerizable chiral compounds can be selected for example from the above formulae. Suitable non polymerizable chiral compounds can be selected e.g. from the commercially available chiral dopants R/S 811, R/S 1011, R/S 2011 or CB 15 (from Merck KGaA, Darmstadt, Germany). Very preferred are chiral compounds with a high helical twisting power (HTP), in particular compounds comprising a sorbitol group as described in WO 98/00428, compounds comprising a hydrobenzoin group as described in GB 2,328,207, chiral binaphthyl derivatives as described in WO 02/94805, chiral binaphthol acetal derivatives as described in WO 02/34739, chiral TADDOL derivatives as described in WO 02/06265, and chiral compounds having at least one fluorinated linkage group and a terminal or central chiral group as described in WO 02/06196 and WO 02/06195. The amount of chiral dopants in the liquid crystal material is preferably less than 15%, in particular from 0.01 to 10%, very preferably from 0.1 to 5% by weight of the total liquid crystal material (without solvent).

Planar alignment of the liquid crystal material can be achieved for example by shearing the material, e.g. by means of a doctor blade. It is also possible to apply an alignment layer, for example a layer of rubbed polyimide or sputtered SiOx, on top of at least one of the substrates. Planar alignment can also be achieved by rubbing the substrate without applying an additional alignment layer, e.g. by means of a rubbing cloth or a rubbing roller. If a rubbed substrate is used for the preparation of a retardation film according to the invention, the direction of the optical axis of the film usually corresponds to the rubbing direction of the substrate.

Planar alignment with a low tilt angle can also be achieved or enhanced by adding one or more surfactants to the polymerizable mesogenic material. Suitable surfactants are described for example in J. Cognard, Mol. Cryst. Liq. Cryst. 78, Supplement 1, 1-77 (1981). Particularly preferred are non-ionic surfactants, e.g. non-ionic fluorocarbon surfactants, like the commercially available Fluorad® (from 3M), or Zonyl FSO® (from DuPont).

Reviews of further alignment techniques are given for example by I. Sage in “Thermotropic Liquid Crystals,” edited by G. W. Gray, John Wiley & Sons, 1987, pages 75-77, and by T. Uchida and H. Seki in “Liquid Crystals—Applications and Uses Vol. 3,” edited by B. Bahadur, World Scientific Publishing, Singapore 1992, pages 1-63. A review of alignment materials and techniques is given by J. Cognard, Mol. Cryst. Liq. Cryst. 78, Supplement 1 (1981), pages 1-77.

Polymerization of the material can take place by exposing it to heat or actinic radiation. Actinic radiation means irradiation with light, like UV light, IR light or visible light, irradiation with X-rays or gamma rays or irradiation with high energy particles, such as ions or electrons. Preferably polymerization is carried out by UV irradiation. As a source for actinic radiation for example a single UV lamp or a set of UV lamps can be used. When using a high lamp power the curing time can be reduced. Another possible source for actinic radiation is a laser, like e.g. a UV laser, an IR laser or a visible laser.

The polymerization is carried out in the presence of an initiator absorbing at the wavelength of the actinic radiation. For example, when polymerizing by means of UV light, a photoinitiator can be used that decomposes under UV irradiation to produce free radicals or ions that start the polymerization reaction. When curing polymerizable compounds with acrylate or methacrylate groups, preferably a radical photoinitiator is used, when curing polymerizable compounds with vinyl and epoxide groups, preferably a cationic photoinitiator is used. It is also possible to use a polymerization initiator that decomposes when heated to produce free radicals or ions that start the polymerization. As a photoinitiator for radical polymerization for example the commercially available Irgacure® or Darocure® initiators (from Ciba Geigy AG) can be used, whereas in case of cationic photopolymerization the commercially available UVI 6974® (Union Carbide) can be used. The polymerizable material preferably comprises 0.01 to 10%, very preferably 0.05 to 5%, in particular 0.1 to 3% of a polymerization initiator. UV photoinitiators are preferred, in particular radicalic UV photoinitiators.

The curing time is dependent, inter alia, on the reactivity of the polymerizable material, the thickness of the printed layer, the type of polymerization initiator and the power of the UV lamp. The curing time according to the invention is preferably not longer than 10 minutes, particularly preferably not longer than 5 minutes and very particularly preferably shorter than 2 minutes. For mass production short curing times of 3 minutes or less, very preferably of 1 minute or less, in particular of 30 seconds or less, are preferred.

The polymerizable liquid crystal material can additionally comprise one or more other suitable components or additives such as, for example, catalysts, sensitizers, stabilizers, inhibitors, co-reacting monomers, surface-active compounds, lubricating agents, wetting agents, dispersing agents, hydrophobing agents, adhesive agents, flow improvers, defoaming agents, deaerators, diluents, reactive diluents, auxiliaries, colorants, dyes or pigments.

Suitable additives are disclosed for example in WO 00/47694, the entire disclosure of which is incorporated into this application by reference.

In particular the addition of stabilizers is preferred in order to prevent undesired spontaneous polymerization of the polymerizable material for example during storage. As stabilizers in principal all compounds can be used that are known to the skilled in the art for this purpose. These compounds are commercially available in a broad variety. Typical examples for stabilizers are 4-ethoxyphenol or butylated hydroxytoluene (BHT).

Other additives, like e.g. chain transfer agents, can also be added to the polymerizable liquid crystal material in order to modify the physical properties of the resulting polymer film. When adding a chain transfer agent, such as monofunctional thiol compounds like e.g. dodecane thiol or multifunctional thiol compounds like e.g. trimethylpropane tri(3-mercaptopropionate), or a mesogenic or liquid crystalline thiol, to the polymerizable material, the length of the free polymer chains and/or the length of the polymer chains between two crosslinks in the inventive polymer film can be controlled. When the amount of the chain transfer agent is increased, the polymer chain length in the obtained polymer film is decreasing.

It is also possible, in order to increase crosslinking of the polymers, to add up to 20% of a non mesogenic compound with two or more polymerizable groups to the polymerizable liquid crystal material alternatively or in addition to the di- or multireactive polymerizable mesogenic compounds to increase crosslinking of the polymer. Typical examples for direactive non mesogenic monomers are alkyl diacrylates or alkyl dimethacrylates with alkyl groups of 1 to 20 C atoms. Typical examples for non mesogenic monomers with more than two polymerizable groups are trimethylpropane trimethacrylate or pentaerythritol tetraacrylate.

In another preferred embodiment the polymerizable liquid crystal material comprises up to 70%, preferably 3 to 50% of a non mesogenic compound with one polymerizable group. Typical examples for monoreactive non mesogenic monomers are alkyl acrylates or alkyl methacrylates with alkyl groups of 1 to 20 C atoms.

It is also possible to add, for example, a quantity of up to 20% by weight of a non polymerizable liquid crystal compound to adapt the optical properties of the resulting polymer film.

The polymerization is preferably carried out in the liquid crystal phase of the polymerizable liquid crystal material. Therefore, preferably polymerizable mesogenic compounds or mixtures with low melting points and broad liquid crystal phase ranges are used. The use of such materials allows to reduce the polymerization temperature, which makes the polymerization process easier and is a considerable advantage especially for mass production. The selection of suitable polymerization temperatures depends mainly on the clearing point of the polymerizable material and inter alia on the softening point of the substrate. Preferably the polymerization temperature is at least 30 degrees below the clearing temperature of the polymerizable mesogenic mixture. Polymerization temperatures below 120° C. are preferred. Especially preferred are temperatures below 90° C., in particular temperatures of 60° C. or less.

The liquid crystal film obtained by the inventive process can be used in optical elements, like reflective polarizers, retardation films, compensators, color filters or holographic elements, especially in films with patterned optical properties, for the preparation of liquid crystal pigments, in decorative and security applications, especially in security markings that are applied to items or documents of value for easy identification or prevention of falsification, in nonlinear optics, optical recording or information storage.

The liquid crystal film according to the present invention is especially useful as security marking for authentification, identification, verification or prevention of copying or counterfeiting of high value documents like ID cards, passports, bank notes, credit cards, or any product with money value like stamps, tickets, shares, cheques etc. The film can be either included in a laminate or adhesively bound to the surface of the document or as a transparent or watermark area.

The liquid crystal film can be used for direct application e.g. onto an article, device or document, or as thread, strip, hologram, transfer foil or hot stamping foil in decorative or security applications as mentioned above or for the identification of hidden images, informations or patterns. It can be applied to consumer products or household objects, car bodies, foils, packing materials, clothes or woven fabric, incorporated into plastic, or applied as security marking or thread, e.g. strip, on documents of value.

The entire disclosure of all applications, patents and publications, cited herein and of corresponding European application No. 02028174.7, filed Dec. 19, 2002 is incorporated by reference herein.

### EXAMPLES

In the foregoing and in the following examples, unless otherwise indicated, all temperatures are set forth uncorrected in degrees Celsius and all parts and percentages are by weight. Unless stated otherwise, the preferred amounts of mixture components as given above and below relate to a solventless mixture.

### Example 1

The following polymerizable mixture is formulated

| | % of solution | % of solventless mixture |
|---|---|---|
| Toluene | 75.23% | |
| compound A | 3.19% | 12.88% |
| compound B | 5.91% | 23.86% |
| compound C | 6.27% | 25.31% |
| compound D | 6.47% | 26.12% |
| Irgacure 907 ® | 2.06% | 8.32% |
| Iriodin LS800 ® | 0.87% | 3.51% |

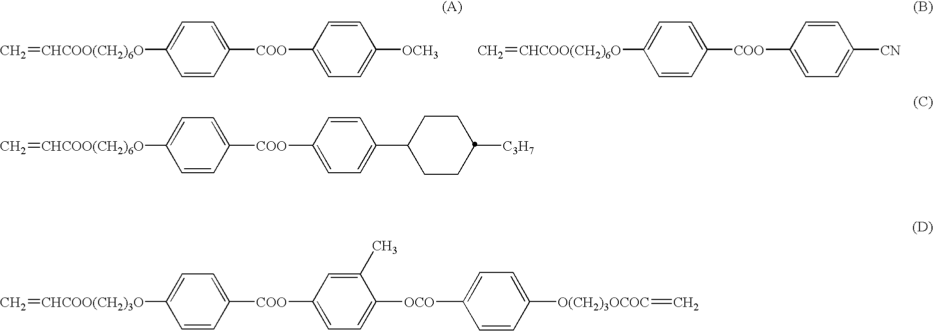

Compounds (A), (B) and (D) can be prepared according to or in analogy to the methods described in D. J. Broer et al., Makromol. Chem. 190, 3201-3215 (1989). Compound (C) and its preparation are described in GB 2,280,445. Irgacure 907® is a commercially available photoinitiator (Ciba Geigy). Iriodin LS800® is a commercially available interference pigment (Merck KGaA).

The solution is coated onto a clear TAC substrate using a white K Bar with a wet film thickness of ca. 4 μm. The solvent is allowed to evaporate off at 50° C. and the coated film then laminated using another TAC laminate. Curing is achieved by irradiation with UV radiation (Mercury vapor lamp). The cured, laminated product is then marked by exposure to laser intensity light. The laser used was a Nd:YAG laser at 1064 nm with a power of 100 W.

When viewed between crossed polarizers, or if the film is viewed through a single linear polarizer against a reflective background, the unmarked film shows distinct birefringence colors as the polarizer is rotated. After laser irradiation the film in the marked region shows as a uniform color that does not change as the polarizer is rotated.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A process for marking a liquid crystal film, which comprises laser irradiating an area of the film such that its optical properties are modified in that area wherein the liquid crystal film comprises a polymerized liquid crystal material and one or more interference pigments.

2. A process according to claim 1, wherein the liquid crystal material is a nematic material.

3. A process according to claim 1, wherein the liquid crystal material is crosslinked.

4. A process according to claim 2, wherein the liquid crystal material is crosslinked.

5. A process according to claim 1, wherein the liquid crystal film is prepared by applying a polymerizable liquid crystal material comprising the interference pigment(s) onto a substrate, aligning the material into uniform orientation and polymerizing or crosslinking the material to fix the orientation, and optionally removing the substrate from the polymer film.

6. A process according to claim 1, wherein the interference pigment(s) are selected from coated mica, silica or alumina pigments.

7. A process according to claim 1, wherein the laser irradiating is with laser light having a wavelength from 100 to 1100 nm.

8. A process according to claim 1, wherein the laser irradiating is with laser light of a power from 10 to 150 W.

9. A process according to claim 1, wherein the laser irradiating is with laser light of a pulse length from 1 to 100 ns.

10. A liquid crystal film with a laser marking obtained by a process according to claim 1.

11. A liquid crystal pigment prepared from a liquid crystal film of claim 10.

12. An optical, decorative, security, authentification or identification document or device comprising a liquid crystal film of claim 10.

13. An optical, decorative, security, authentification or identification document or device comprising a liquid crystal pigment of claim 11.

14. A document or device of claim 12, wherein the liquid crystal film is in the form of a marking or thread on discreet areas of the document or device.

15. A document or device of claim 13, wherein the liquid crystal film is in the form of a marking or thread on discreet areas of the document or device.

16. A document of value, transfer foil, hot stamping foil, reflective foil or optical data storage device, comprising a liquid crystal film of claim 10.
